(19) United States
(12) Patent Application Publication
(10) Pub. No.: US 2024/0259870 A1
(43) Pub. Date: Aug. 1, 2024

(54) TRANSMISSION DEVICE, COMMUNICATION SYSTEM, TRANSMISSION METHOD, AND NON-TRANSITORY COMPUTER-READABLE MEDIUM

(71) Applicant: NEC Corporation, Minato-ku, Tokyo (JP)

(72) Inventors: Kosei KOBAYASHI, Tokyo (JP); Hiroaki AMINAKA, Tokyo (JP); Motoharu OHTAKE, Tokyo (JP); Shinji MIYAZAKI, Tokyo (JP); Yoshikatsu NIWA, Tokyo (JP)

(73) Assignee: NEC Corporation, Minato-ku, Tokyo (JP)

(21) Appl. No.: 18/565,175

(22) PCT Filed: Jun. 2, 2021
(86) PCT No.: PCT/JP2021/021051

§ 371 Date: Nov. 29, 2023

(51) Int. Cl. H04W 28/06; H04L 1/00

(52) U.S. Cl. CPC H04W 28/06; H04L 1/0002

(57) ABSTRACT

A transmission device is a transmission device that transmits communication data to one or more reception devices via a network. A transmission device includes: a specification unit that specifies a reception device number indicating the number of the reception devices that are a destination of communication data; a determination unit that, in a case where the reception device number is a first number, determines a data size or a bit rate of the communication data such that the data size or the bit rate becomes smaller or lower than that in a case where the reception device number is a second number smaller than the first number; a generation unit that generates the communication data by using the determined data size or bit rate; and a transmission unit that transmits the generated communication data to one or more reception devices that are the destination via the network.

### TECHNICAL FIELD

The present disclosure relates to a transmission device, a communication system, a transmission method, and a program.

### BACKGROUND ART

In recent years, a large number of communication terminals are connected to a communication network, and various communication services are provided to the communication terminals connected to the communication network. For example, there is a communication service in which one communication terminal provides the same data to a plurality of communication terminals via a communication network. The data provided from one communication terminal to the plurality of communication terminals includes, for example, text data, image data, video data, or the like.

Patent Literature 1 discloses a multicast configuration as a communication mode in which a transmission device and a reception device form one to N (N is an integer of 2 or more). The transmission device transmits data to the node device via the Internet, and the node device transmits the data to the reception device connected to the wireless access point device. The value of the communication band allocated to the communication flow for the multicast group is determined according to the maximum communication band of the cell formed by the wireless access point device and the number of reception devices participating in the multicast group. The node device allocates a communication band to the communication flow according to the determined communication band.

### CITATION LIST

### Patent Literature

Patent Literature 1: Japanese Unexamined Patent Application Publication No. 2004-040666

### SUMMARY OF INVENTION

### Technical Problem

In Patent Literature 1, since the value of the communication band allocated to the communication flow is determined according to the number of reception devices participating in the multicast group, for example, as the number of reception devices increases, the number of data transferred in the communication network increases. As a result, there is a problem that an increase in the number of reception devices causes congestion of the communication network.

In view of the above problems, an object of the present disclosure is to provide a transmission device, a communication system, a transmission method, and a program capable of suppressing a load of a communication network in a case where the number of reception devices increases.

### Solution to Problem

A transmission device according to a first aspect of the present disclosure is a transmission device that transmits communication data to one or more reception devices via a network, the transmission device including: a specification means for specifying a reception device number indicating the number of the reception devices that are a destination of the communication data; a determination means for determining, in a case where the reception device number is a first number, a data size or a bit rate of the communication data such that a data size or a bit rate becomes smaller or lower than that in a case where the reception device number is a second number smaller than the first number; a generation means for generating the communication data using the determined data size or bit rate; and a transmission means for transmitting the communication data generated to one or more of the reception devices that are the destination via the network.

A communication system according to a second aspect of the present disclosure includes: a transmission device configured to transmit communication data to one or more reception devices via a network; and a server configured to specify a reception device number indicating the number of the reception devices that are a destination of the communication data, determine, in a case where the number of the reception devices that are a destination of the communication data is a first number, a data size or a bit rate of the communication data such that a data size or a bit rate becomes smaller or lower than that in a case where the reception device number is a second number smaller than the first number, and transmit the data size or the bit rate determined to the transmission device, in which the transmission device generates the communication data using the data size or the bit rate determined, and transmits the communication data generated to one or more of the reception devices that are the destination via the network.

A transmission method according to a third aspect of the present disclosure is a transmission method executed in a transmission device that transmits communication data to one or more reception devices via a network, the transmission method including: specifying a reception device number indicating the number of the reception devices that are a destination of the communication data; determining, in a case where the reception device number is a first number, a data size or a bit rate of the communication data such that a data size or a bit rate becomes smaller or lower than that in a case where the reception device number is a second number smaller than the first number; generating the communication data using the determined data size or bit rate; and transmitting the communication data generated to one or more of the reception devices that are the destination via the network.

A program according to a fourth aspect of the present disclosure is a program for causing a computer, which transmits communication data to one or more reception devices via a network, to execute: specifying a reception device number indicating the number of the reception devices that are a destination of the communication data; determining, in a case where the reception device number is a first number, a data size or a bit rate of the communication data such that a data size or a bit rate becomes smaller or lower than that in a case where the reception device number is a second number smaller than the first number; generating the communication data using the determined data size or bit rate; and transmitting the communication data generated to one or more of the reception devices that are the destination via the network.

### Advantageous Effects of Invention

According to the present disclosure, it is possible to provide a transmission device, a communication system, a transmission method, and a program capable of suppressing a load of a communication network in a case where the number of reception devices increases.

### BRIEF DESCRIPTION OF DRAWINGS

FIG. 1 is a configuration diagram of a transmission device according to a first example embodiment.

FIG. 2 is a configuration diagram of a communication system according to a second example embodiment.

FIG. 3 is a diagram showing a flow of transmission processing in a transmission device according to the second example embodiment.

FIG. 4 is a configuration diagram of a communication system according to a third example embodiment.

FIG. 5 is a configuration diagram of a transmission device according to the third example embodiment.

FIG. 6 is a configuration diagram of a server device according to the third example embodiment.

FIG. 7 is a diagram showing a flow of transmission processing of communication data according to the third example embodiment.

FIG. 8 is a configuration diagram of a communication system according to a fourth example embodiment.

FIG. 9 is a configuration diagram of a transmission device according to the fourth example embodiment.

FIG. 10 is a configuration diagram of a transmission device and a server device according to each example embodiment.

### EXAMPLE EMBODIMENT

### First Example Embodiment

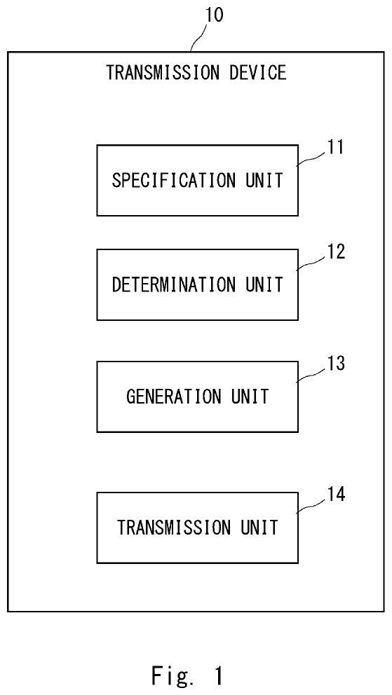

Example embodiments of the present disclosure will be described below with reference to the drawings. A configuration example of a transmission device 10 according to a first example embodiment will be described with reference to FIG. 1. The transmission device 10 may be a computer device that operates when a processor executes a program stored in a memory. The transmission device 10 may be a mobile terminal such as a smartphone terminal or a tablet terminal, or may be a laptop terminal or the like. The transmission device 10 may be rephrased as a transmission terminal. Alternatively, the transmission device 10 may be a relay device that relays end-to-end data communication, and may be, for example, a relay device that relays data communication in a mobile network. Alternatively, the transmission device 10 may be a server device. In a case where the transmission device 10 is used as a server device, the transmission device 10 receives communication data from a transmission terminal such as a smartphone terminal and transmits the communication data to another communication device.

The transmission device 10 transmits communication data to one or more reception devices via a network. Communication data may be, for example, text data, image data, sound data, or video data, or a combination of these data. The network may be the so-called Internet or may include a network managed by a telecommunications carrier as part of it. The network managed by the telecommunications carrier may be referred to as a mobile network, for example. The reception device may be a computer device that operates when a processor executes a program stored in a memory. The reception device may be a mobile terminal such as a smartphone terminal or a tablet terminal, or may be a laptop terminal or the like. The reception device may be rephrased as a reception terminal.

The transmission device 10 includes a specification unit 11, a determination unit 12, a generation unit 13, and a transmission unit 14. The constituent component of the transmission device 10 such as the specification unit 11, the determination unit 12, the generation unit 13, and the transmission unit 14 may be a software or a module in which processing is executed by a processor executing a program stored in a memory. Alternatively, the constituent component of the transmission device 10 may be hardware such as a circuit or a chip.

The specification unit 11 specifies a reception device number indicating the number of reception devices that are a destination of the communication data. For example, the specification unit 11 specifies a reception device number indicating the number of reception devices that are the destination of the identical communication data. The specification unit 11 may acquire information related to the reception device number from an application installed in the transmission device 10. The application may be an application related to message communication that enables transmission of communication data to one or more reception devices. Alternatively, the specification unit 11 may receive information related to the reception device number from a server device or the like that provides a service for transmitting communication data to one or more reception devices.

The determination unit 12 determines, in a case where the reception device number is a first number, the data size or the bit rate of the communication data such that the data size or the bit rate becomes smaller or lower than that in a case where the reception device number is a second number smaller than the first number. The data size and the bit rate determined by the determination unit 12 do not need to be absolute values, and may be relative values. For example, directionality of change such as “decrease” or “increase” of the data size or the bit rate may be determined, and a change ratio such as “halve” or “1.5 times” may be determined.

The second number may be used as a threshold, for example. That is, the determination unit 12 may determine the data size or the bit rate of the communication data according to whether or not the reception device number is larger than the second number that is the threshold value. The determination unit 12 may determine, in a case where the reception device number is smaller than the second number, the data size or the bit rate of the communication data such that the data size or the bit rate becomes larger or higher than that in a case where the reception device number is the second number.

The generation unit 13 generates communication data using the determined data size or bit rate. The data size may be, for example, a size of application data generated in the application. The bit rate may be rephrased as a throughput.

In addition, in a case where communication data is received from a transmission terminal such as a smartphone terminal, the transmission device 10 applies the determined data size or bit rate to the received communication data.

The transmission unit 14 transmits the communication data generated by the generation unit 13 to one or more reception devices that are the destination via a network.

As described above, the transmission device 10 determines the data size or the bit rate of the communication data according to the number of reception devices, and transmits the communication data to the reception devices. Specifically, the transmission device 10 decreases the data size or lowers the bit rate as the number of reception devices increases. As a result, it is possible to suppress an increase in the amount of data to be transmitted in a case where the number of reception devices increases. By suppressing the increase in the amount of data to be transmitted in this manner, it is possible to suppress the occurrence of packet loss and the increase in delay as compared with a case of executing a processing of decreasing the communication band according to the increase in the number of reception devices. In addition, in a case where the number of reception devices increases by decreasing the data size or lowering the bit rate as the number of reception devices increases, the amount of data relayed in the network does not increase in proportion to the increase in the number of reception devices. Therefore, by using the transmission device 10, the possibility of occurrence of network congestion caused by an increase in the number of reception devices can be suppressed, and the load on the network can be suppressed.

### Second Example Embodiment

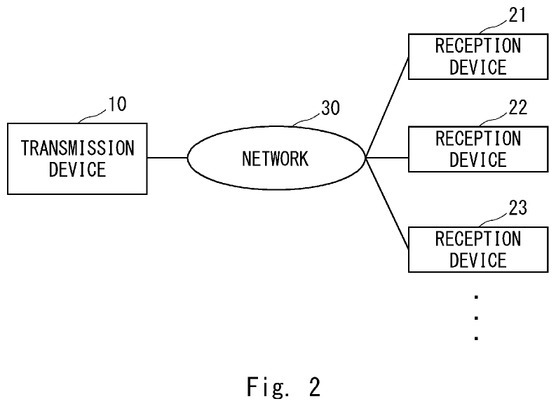

Next, a configuration example of a communication system according to a second example embodiment will be described with reference to FIG. 2. The communication system of FIG. 2 shows that the transmission device 10 communicates with reception devices 21 to 23 via a network 30. The transmission device 10 and the reception device 21 to 23 may be connected to the network 30 via a wireless communication line or may be connected to the network 30 via a wired communication line. Although FIG. 2 shows three reception devices, the transmission device 10 may transmit communication data to three or more reception devices, or may transmit communication data to two or less reception devices.

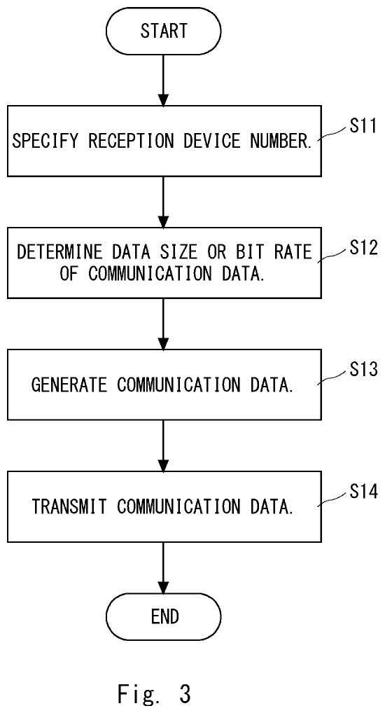

Next, a flow of transmission processing in the transmission device 10 according to the second example embodiment will be described with reference to FIG. 3. First, the specification unit 11 specifies the number of reception devices that are the destination of communication data (S11). For example, a user who uses the transmission device 10 activates an application related to message communication and inputs the destination for each reception device together with a message. The specification unit 11 may specify the number of reception devices that are the destination of communication data by acquiring information related to the destination input by the user from the application. A plurality of reception devices associated with a destination input by a user receives the same communication data. The destination is not limited to the case of being input by the user, and for example, the specification unit 11 may acquire information related to the destination held in the application.

The destination may be, for example, information for identifying the reception devices 21 to 23. The information for identifying the reception devices 21 to 23 is, for example, information for uniquely identifying each reception device connected to the network 30. Specifically, the destination may be a telephone number, an e-mail address, an IP address, a media access control (MAC) address, a fully qualified domain name (FQDN), or identification information assigned by a carrier providing a service related to message communication.

Alternatively, identification information related to a plurality of reception devices may be associated with one piece of identification information. For example, one piece of identification information may be referred to as a group address. The information in which the group address is associated with the identification information related to the plurality of reception devices may be stored in a memory or the like in the transmission device 10.

In a case where the user inputs the group address, the specification unit 11 may extract the identification information of the reception device associated with the group address from the memory or the like and specify the number of pieces of the extracted identification information.

Next, the determination unit 12 determines the data size or the bit rate of the communication data according to the reception device number (S12). Specifically, in order to reduce the amount of data transmitted in the network 30, the determination unit 12 decreases the data size or lowers the bit rate as the reception device number increases. The data size is, for example, a size of one packet or frame. The data size may be, for example, a size of data in a case where a plurality of packets or a plurality of frames are summed. The bit rate is an amount of data transmitted per unit time from the transmission device 10 to the network 30, and may be referred to as a throughput.

The determination unit 12 may, for example, decrease the data size or lower the bit rate such that the amount of data to be increased is less than the amount of data to be increased in proportion to the increase number of reception devices. Alternatively, the determination unit 12 may decrease the data size or lower the bit rate such that the amount of data transmitted in the network 30 still does not change in a case where the reception device number increases. In a case where the reception device number is N, the data size or the bit rate is R, and a function for deriving R from N is F (R=F (N)), an arbitrary monotonically decreasing function may be used as the function F.

For example, the determination unit 12 may store information in which the reception device number, the communication data type, and the data size are associated in the memory or the like. The communication data type may be, for example, information indicating text data, image data, sound data, or video data. For example, in a case where the communication data type is video data and the reception device number is N (N is an integer of 1 or more), the data size may be determined as X bits (X is a positive real number). The data size decreases as the reception device number increases.

Alternatively, the determination unit 12 may determine the data size of the video data such as X_1 bit in a case where the reception device number exceeds a predetermined threshold, and X_2 bit (X_1<X_2) in a case where the reception device number does not exceed the threshold. That is, the determination unit 12 may compare the reception device number with the threshold value, and determine the data size according to whether or not the reception device number exceeds the threshold value.

Alternatively, the determination unit 12 may determine the data size in consideration of the congestion status of the network 30. The congestion status may be a load status of a network device in the network 30, an amount of data transmitted in the network 30, or the like. For example, the information related to the congestion status of the network 30 may be acquired from a network device in the network 30, a management device that manages the network 30, or the like.

It is assumed that the reception device number in a state where the network 30 is congested or in a state where the load of the network device is higher than the threshold is the same as the reception device number in a state where the network 30 is not congested or in a state where the load of the network device is lower than the threshold. In such a case, the determination unit 12 may make the data size of the communication data in a state where the network 30 is congested smaller than the data size of the communication data in a state where the network 30 is not congested.

The determination unit 12 may determine the bit rate (bps: bit/sec) instead of the data size according to the reception device number.

Next, the generation unit 13 generates communication data by using the data size or the bit rate determined in step S12 (S13). For example, the generation unit 13 may generate the communication data by adding address information indicating a destination of the communication data to a header of the communication data to which the data size or the bit rate determined in step S12 is applied. In a case where the generation unit 13 is connected to the network 30 via a wireless communication line, communication data modulated for wireless transmission or the like may be generated as the communication data.

The generation unit 13 generates communication data for each reception device. In other words, the generation unit 13 generates communication data that has the reception device 21 as the destination, communication data that has the reception device 22 as the destination, and communication data that has the reception device 23 as the destination, respectively. The generation unit 13 may change the destination and generate communication data corresponding to the reception device number to be the destination of the communication data, or may include a plurality of destinations in one communication data. In addition, communication data may be generated in which group identification information for identifying one or more reception terminals that are the destination of the communication data is set as a destination.

The generation unit 13 may change the data size or the bit rate to be applied to the communication data by changing a compression parameter of image data, sound data, or video data. The compression parameter may be, for example, a compression rate, a quantization accuracy, a sampling rate, a resolution, a compression protocol, or the like. The compression parameter may be a parameter of lossy compression or a parameter of lossless compression. For example, in a case of video data, the data size or the bit rate can be reduced by a method such as increasing the compression rate of lossy compression, decreasing the quantization accuracy, decreasing the sampling rate, decreasing the resolution, or using a compression protocol with a higher compression rate. Here, the quantization accuracy means the amount of information assigned per pixel of an image. Further, the sampling rate means the number of video frames per unit time, and may be referred to as a frame rate. Further, the resolution means the number of pixels in the vertical direction and the horizontal direction of an image. The compression protocol means a moving image compression standard such as H.264 or H.265. In a case of image data, sound data, and the like, the data size or the bit rate can still be changed by changing the compression parameter as in the case of video data described above.

Next, the transmission unit 14 transmits the communication data generated in step S13 to the reception devices 21 to 23 via the network 30 (S14). For example, the transmission unit 14 transmits communication data to each reception device by using unicast communication. The transmission unit 14 may transmit the communication data to each reception device by using multicast communication.

As described above, the transmission device 10 determines the data size or the bit rate of the communication data according to the number of reception devices, and transmits the communication data to the reception devices. Furthermore, the transmission device 10 determines the data size or the bit rate of the communication data in consideration of the load status of the network 30 and the like. As a result, in a state where the load of the network 30 is high, it is possible to reduce the data amount of the communication data transmitted through the network 30, and thus, it is possible to suppress the load of the network 30 even when the number of reception devices increases.

### Third Example Embodiment

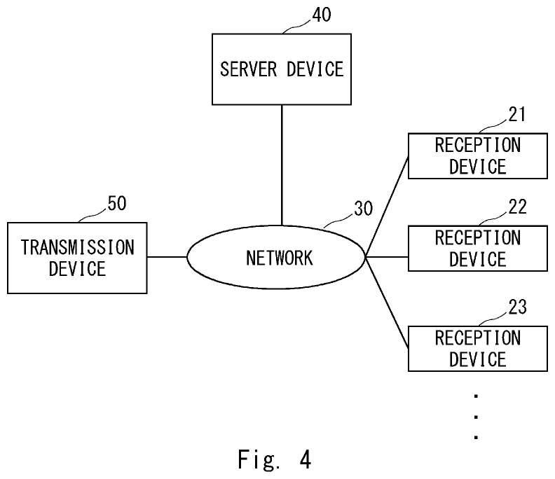

Next, a configuration example of a communication system according to a third example embodiment will be described with reference to FIG. 4. The communication system in FIG. 4 has a configuration in which a server device 40 is added to the communication system in FIG. 2. In the communication system in FIG. 4, the transmission device 10 in FIG. 2 is replaced with a transmission device 50. The server device 40 may be a computer device that operates when a processor executes a program stored in a memory. The server device 40 communicates with the transmission device 50 via a network 30.

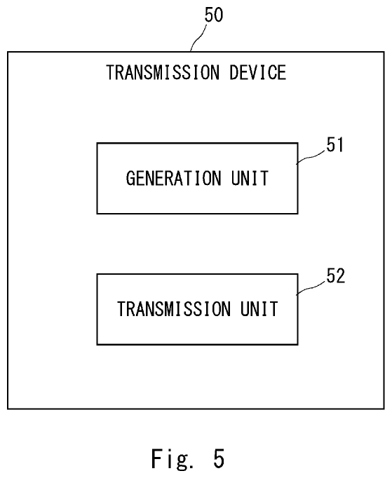

Next, a configuration example of the transmission device 50 according to the third example embodiment will be described with reference to FIG. 5. The transmission device 50 includes a generation unit 51 and a transmission unit 52. The generation unit 51 and the transmission unit 52 correspond to the generation unit 13 and the transmission unit 14 in FIG. 1, respectively. Hereinafter, operations, functions, and the like of the generation unit 51 and the transmission unit 52 different from those of the generation unit 13 and the transmission unit 14 will be mainly described. Furthermore, the transmission unit 52 may be replaced with a communication unit. That is, the transmission unit 52 may transmit data and be used to receive data.

The generation unit 51 generates an inquiry message including the group address input from a user. The group address is associated with identification information of one or more reception devices. The inquiry message is used to inquire of the server device 40 about identification information of one or more reception devices associated with the group address. Therefore, the generation unit 51 sets the address of the server device 40 as the destination of the inquiry message.

The transmission unit 52 transmits the inquiry message to the server device 40 according to the destination of the inquiry message generated by the generation unit 51. In addition, the transmission unit 52 receives a response message to the inquiry message from the server device 40. The response message includes identification information of the reception device associated with the group address, and information of the data size or the bit rate to be applied to communication data to be transmitted to the reception device.

In a case where identification information of a plurality of reception devices is included, the generation unit 51 generates communication data having a destination as the identification information for each reception device. Further, the generation unit 51 applies the data size or the bit rate notified from server device 40 as the data size or the bit rate of the communication data.

The transmission unit 52 transmits the communication data generated by the generation unit 51 for each reception device to each reception device via the network 30.

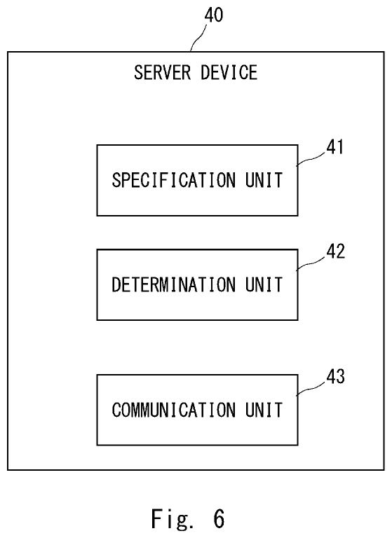

Next, a configuration example of the server device 40 according to the third example embodiment will be described with reference to FIG. 6. The server device 40 includes a specification unit 41, a determination unit 42, and a communication unit 43. The specification unit 41 and the determination unit 42 correspond to the specification unit 11 and the determination unit 12 in FIG. 1, respectively. The specification unit 41, the determination unit 42, and the communication unit 43 may be software components or modules whose processing is carried out by causing the processor to execute the program stored in the memory. Alternatively, the specification unit 41, the determination unit 42, and the communication unit 43 may be hardware such as a circuit or a chip.

The specification unit 41 manages the group address and the identification information related to the plurality of reception devices in association with each other. For example, the information in which the group address is associated with the identification information related to the plurality of reception devices may be stored in a memory or the like in the server device 40.

When the group address is received from the transmission device 50 via the communication unit 43, the specification unit 41 extracts the identification information of the reception device associated with the group address from the memory. Further, the specification unit 41 specifies the number of pieces of extracted identification information as the number of reception devices that are the destination.

The determination unit 42 determines the data size or the bit rate of the communication data according to the reception device number. In order to reduce the amount of data transmitted in the network 30, the determination unit 42 decreases the data size or lowers the bit rate as the reception device number increases. The determination unit 42 may, for example, decrease the data size or lower the bit rate such that the amount of data to be increased is less than the amount of data to be increased in proportion to the increase number of reception devices. Alternatively, the determination unit 42 decreases the data size or lowers the bit rate such that the amount of data transmitted in the network 30 still does not change in a case where the reception device number increases.

Furthermore, the determination unit 42 may determine the data size in consideration of the congestion status of the network 30. The congestion status may be a load status of a network device in the network 30, an amount of data transmitted in the network 30, or the like. For example, the server device 40 may monitor the network device in the network 30 or the congestion status of the network 30 or the load status of the network device. For example, the server device 40 may periodically receive, from one or more network devices in the network 30, information related to the load status, the number of communication data processes, the number of communication data relays, the amount of relayed communication data, and the like.

The communication unit 43 transmits a response message including the identification information of the reception device extracted by the specification unit 41 and the data size or the bit rate to be applied to the communication data to the transmission device 50.

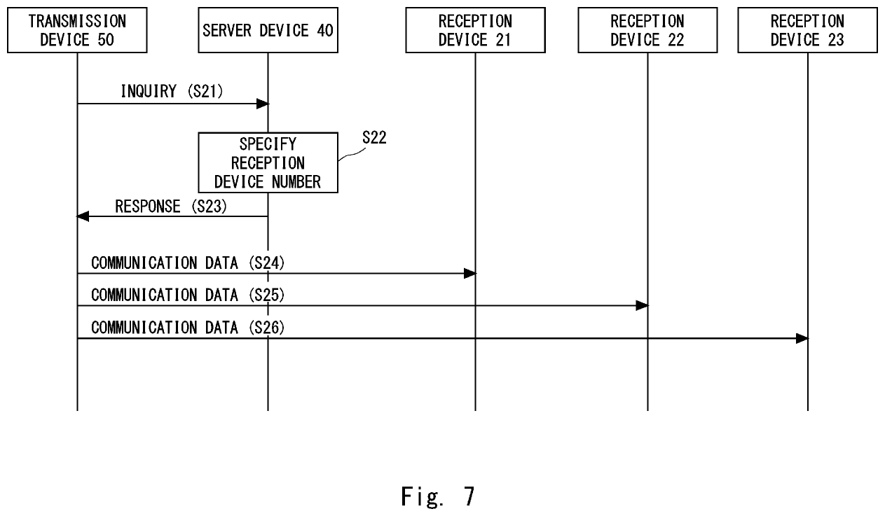

Next, a flow of transmission processing of communication data according to the third example embodiment will be described with reference to FIG. 7. First, the transmission device 50 transmits an inquiry message to the server device 40 (S21). The inquiry message includes the group address input by a user.

Next, the server device 40 extracts identification information of the reception device associated with the group address, and specifies the number of reception devices (S22). Here, it is assumed that the group address is associated with the reception devices 21 to 23. Next, the server device 40 transmits a response message, which includes the identification information of the reception device and the data size or the bit rate to be applied to the communication data, to the transmission device 50 (S23).

Next, the transmission device 50 generates communication data for each reception device included in the response message, and transmits the generated communication data to the reception devices 21 to 23 (S24 to S26). In each piece of communication data, identification information of each reception device is set as the destination. Further, the data size or the bit rate included in the response message is applied as the data size or the bit rate of the communication data.

As described above, the transmission device 50 transmits, to one or more reception devices, the communication data to which the data size or the bit rate of the communication data determined by the server device 40 is applied. Generally, the processing capability, the memory amount, and the like of the transmission device 50 are lower or smaller than those of the server device 40. Therefore, by the server device 40 executing the processing of determining the data size or the bit rate, the processing load of the transmission device 50 can be reduced as compared with a case where the transmission device 50 determines the data size or the bit rate. In addition, the server device 40 can centrally manage the policy of the relationship between the reception device number and the data size or the bit rate. In this case, in a case where there are a plurality of transmission devices 50, the same policy still can be applied to the plurality of transmission devices 50. Furthermore, it is only necessary to change the policy managed by the server device 40 in a case of a policy change.

### (Modified Example of Third Example Embodiment)

In the third example embodiment, the configuration in which the transmission device 50 includes the generation unit 51 and the transmission unit 52 and the server device 40 includes the specification unit 41 and the determination unit 42 has been described. However, for example, the specification unit 41 may be included in the transmission device 50. In this case, the transmission device 50 transmits the inquiry message including information related to the number of specified reception devices to the server device 40. Further, the server device 40 determines the data size or the bit rate to be applied to the communication data by using the number of reception devices included in the inquiry message.

Alternatively, the server device 40 may include the specification unit 41, the determination unit 42, the generation unit 51, and the transmission unit 52. For example, the transmission device 50 transmits communication data to one or more reception devices via the server device 40. In this case, the transmission device 50 may transmit communication data and identification information of one or more reception devices that are the destination of the communication data to the server device 40. Note that the transmission device 50 may transmit, to the server device 40, a group address corresponding to one or more reception devices that are the destination of the communication data together with the communication data instead of the identification information of one or more reception devices that are the destination of the communication data. The server device 40 specifies the number of reception devices by using the identification information, received from the transmission device 50, of one or more reception devices that are the destination of the communication data. Further, the server device 40 determines the data size or the bit rate of communication data according to the number of reception devices, and generates communication data to which the determined data size or bit rate is applied. Further, the server device 40 transmits the generated communication data to one or more reception devices that are the destination of the communication data. Furthermore, in a case where the transmission device 50 is the transmission device 10 including the specification unit 11, the determination unit 12, the generation unit 13, and the transmission unit 14 in FIG. 1, the transmission device 10 may still transmit the group address to the server device 40. In this case, after receiving the group address and the communication data, the server device 40 may transmit the communication data to one or more reception devices that are the destination of the communication data.

As described above, there are a plurality of variations in the function arrangement of the specification unit 41, the determination unit 42, the generation unit 51, and the transmission unit 52 in the transmission device 50 and the server device 40. As described above, by having a plurality of variations related to the functional arrangement, a flexible network design can be performed.

### Fourth Example Embodiment

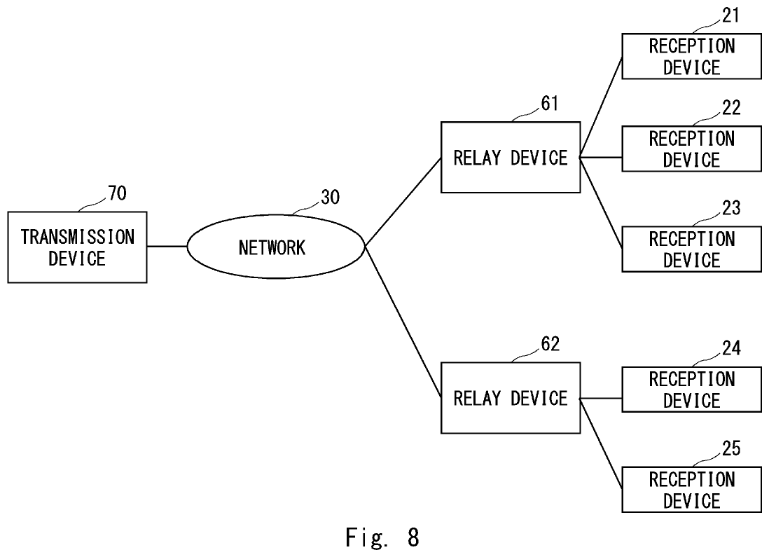

Next, a configuration example of a communication system according to a fourth example embodiment will be described with reference to FIG. 8. In the communication system in FIG. 8, a relay device 61, a relay device 62, a reception device 24, and a reception device 25 are added to the communication system in FIG. 2. In the communication system in FIG. 8, the transmission device 10 is replaced with a transmission device 70.

The relay device 61 and the relay device 62 may be computer devices that operate when a processor executes a program stored in a memory. The relay device 61 and the relay device 62 may be base stations in a mobile network represented by 4G, 5G, or the like. Furthermore, the relay device 61 and the relay device 62 may be a gateway device that aggregates a plurality of base stations, for example, a P-GW or an S-GW in a 4G network, a UPF in a 5G network, or the like. The base station forms a cell which is a communication area, and relays communication data related to a reception device existed in the cell.

The reception devices 21 to 25 in FIG. 8 receives the communication data transmitted from the transmission device 70. It is assumed that the communication data received by each of the reception devices 21 to 25 is the same.

In a case where the relay device 61 is a gateway device that aggregates a plurality of base stations, the reception devices 21 to 23 may exist in the same cell, or may exist in different cells, or two reception devices among the reception devices 21 to 23 may exist in the same cell. Furthermore, in a case where the relay device 62 is a gateway device, the reception devices 24 to 25 may exist in the same cell or may exist in different cells.

In case where the relay device 61 is a base station, the reception devices 21 to 23 exist in the same cell. Furthermore, in a case where the relay device 62 is a base station, the reception devices 24 to 25 exist in the same cell.

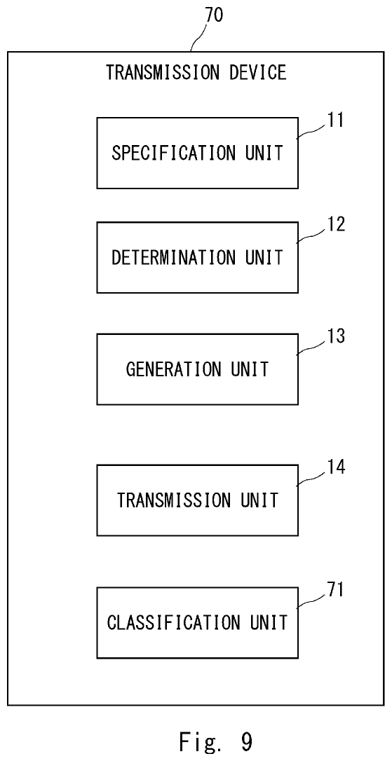

Here, a configuration example of the transmission device 70 will be described with reference to FIG. 9. The transmission device 70 is configured by adding a classification unit 71 to the transmission device 10 in FIG. 1. The specification unit 11 of the transmission device 70 acquires, for example, information related to a destination of the same communication data from an application. The classification unit 71 classifies the reception devices 21 to 25 that are the destination of communication data into a subgroup having an identical relay device to be routed through. Specifically, the classification unit 71 classifies the reception devices 21 to 25 that are the destination of communication data into a subgroup including the reception devices 21 to 23 to be routed through the relay device 61 and a subgroup including the reception devices 24 to 25 to be routed through the relay device 62. For example, the classification unit 71 may acquire information of cells to which each of the reception devices 21 to 25 belongs from an application installed in each of the reception devices 21 to 25. Alternatively, the classification unit 71 may acquire information of cells to which each of the reception devices 21 to 25 belongs from a network device in the mobile network. The network device in the mobile network may be the relay device 61 and the relay device 62, or may be a network exposure function (NEF) entity or the like in the 5G network. The classification unit 71 may classify the reception devices 21 to 25 into a subgroup by using information of cells to which the reception devices 21 to 25 belong. The specification unit 11 specifies the number of reception devices for each subgroup using the classification result in the classification unit 71. That is, in the example of FIG. 8, the specification unit 11 specifies that three reception devices belong to the subgroup formed by the relay device 61 and two reception devices belong to the subgroup formed by the relay device 62. For example, in a case where a server device that provides a service related to message communication manages a terminal group and a subgroup, the specification unit 11 may acquire information related to the reception device belonging to each subgroup from the server device. Alternatively, the core network device managed by the mobile communication carrier may manage the terminal group and the subgroup. In this case, the specification unit 11 may obtain, from the core network device, information related to the reception device belonging to each subgroup. Alternatively, in a case where the position of each reception device belonging to the same terminal group is recognized, the specification unit 11 may classify the reception device into a subgroup based on the position of each reception device. For example, the specification unit 11 classifies one or more reception devices existing in a cell formed by a certain base station into the same subgroup. The server device or the core network device may similarly classify the reception device into a subgroup based on the position of the reception device. Alternatively, the classification unit 71 may classify the reception device into a subgroup based on other information. The other information may be, for example, information indicating whether the reception device is a mobile terminal or a fixed terminal, or may be information indicating whether the reception device is an IoT terminal or other terminals.

The determination unit 12 may determine the data size or the bit rate of the communication data for each subgroup. Specifically, as shown in FIG. 8, it is assumed that the number of reception devices belonging to the subgroup formed by the relay device 61 is larger than the number of reception devices belonging to the subgroup formed by the relay device 62. In this case, the determination unit 12 may make the data size of the communication data having the reception devices 21 to 23 as the destination smaller than the data size of the communication data having the reception devices 24 to 25 as the destination. Alternatively, the determination unit 12 may make the bit rate of the communication data having the reception devices 21 to 23 as the destination lower than the bit rate of the communication data having the reception devices 24 to 25 as the destination.

By changing the data size or the bit rate of communication data for each subgroup in this manner, it is possible to suppress the processing load of the relay device in a case where the number of reception devices belonging to the subgroup increases.

Alternatively, the determination unit 12 may determine the data size or the bit rate to be commonly applied to all the reception devices 21 to 25 that are the destination of communication data. Specifically, the determination unit 12 first determines the data size or the bit rate for each subgroup. Here, it is assumed that there are a total of P subgroups, and the data size or the bit rate determined for each subgroup are Q1, Q2, . . . , and Qp. At this time, the determination unit 12 may determine the minimum value of Q1 to Qp as the data size or the bit rate to be commonly applied. Alternatively, the median value of Q1 to Qp may be determined as the data size or the bit rate to be commonly applied. Alternatively, the determination unit 12 may calculate an arbitrary statistical value for Q1 to Qp to determine the calculated arbitrary statistical value as the data size or the bit rate to be commonly applied. In this case, a common data size or bit rate can be applied to all the reception devices 21 to 25 that are the destination of communication data. Therefore, the processing load related to the generation of the communication data can be reduced as compared with a case where the data size or the bit rate of the communication data is determined for each subgroup.

In the example of FIG. 8, the configuration example in which the server device does not exist has been described. However, in the communication system of FIG. 8, as shown in FIG. 4, the server device 40 may be added, and the transmission device 50 may be used.

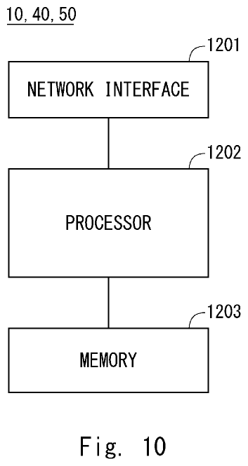

FIG. 10 is a block diagram showing configuration examples of the transmission device 10, the server device 40, and the transmission device 50 (hereinafter, referred to as the transmission device 10 or the like). Referring to FIG. 10, the transmission device 10 or the like includes a network interface 1201, a processor 1202, and a memory 1203. The network interface 1201 may be used to communicate with other network nodes. The network interface 1201 may include, for example, a network interface card (NIC) conforming to IEEE 802.3 series.

The processor 1202 reads and executes software (computer program) from the memory 1203 to perform processing in the transmission device 10 or the like described with reference to the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted of a combination of a volatile memory and a nonvolatile memory. The memory 1203 may include a storage disposed away from the processor 1202. In this case, the processor 1202 may access the memory 1203 through an input/output (I/O) interface (not shown).

In the example of FIG. 10, the memory 1203 is used to store a software module group. The processor 1202 can perform the processing in the transmission device 10 or the like described in the above-described example embodiments by reading and executing these software module groups from the memory 1203.

As described with reference to FIG. 10, each of the processors included in the transmission device 10 or the like in the above-described example embodiments executes one or a plurality of programs including a command group for causing a computer to perform the algorithm described with reference to the drawings.

The program includes a command group (or software code) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storage, and a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium include electrical, optical, acoustic, signals, or propagated signals in other forms.

Note that the present disclosure is not limited to the above-described example embodiments, and can be appropriately modified without departing from the gist.

A portion or all of the example embodiments described above can be described as in the following supplementary notes, but the present invention is not limited to the following notes.

### (Supplementary Note 1)

A transmission device that transmits communication data to one or more reception devices via a network, the transmission device including:
specification means for specifying a reception device number indicating the number of the reception devices that are a destination of the communication data;
determination means for determining, in a case where the reception device number is a first number, a data size or a bit rate of the communication data such that a data size or a bit rate becomes smaller or lower than that in a case where the reception device number is a second number smaller than the first number;
generation means for generating the communication data using the determined data size or bit rate; and
transmission means for transmitting the generated communication data to one or more of the reception devices that are the destination via the network.

### (Supplementary Note 2)

The transmission device according to supplementary note 1, in which
a destination of the communication data is a terminal group including one or more of the reception devices, and
the specification means is configured to specify the reception device number based on group identification information for identifying the terminal group.

### (Supplementary Note 3)

The transmission device according to supplementary note 2, in which the specification means is configured to acquire the reception device number belonging to the terminal group from a server that manages information related to the terminal group.

### (Supplementary Note 4)

The transmission device according to any one of supplementary notes 1 to 3, further including classification means for classifying one or more of the reception devices that are a destination of the communication data into a subgroup having an identical relay device to be routed through in the network, in which
the specification means is configured to specify the reception device number for each of the subgroups, and
the determination means is configured to determine a data size or a bit rate of the communication data by using the reception device number specified for each subgroup.

### (Supplementary Note 5)

The transmission device according to supplementary note 4, in which the determination means is configured to determine a data size or a bit rate of the communication data by using the reception device number of the subgroup specified among the reception device number specified for each subgroup.

### (Supplementary Note 6)

The transmission device according to supplementary note 4, in which the determination means is configured to determine, for each of the subgroups, in a case where the reception device number in the subgroup is a third number, a data size or a bit rate of the communication data such that a data size or a bit rate becomes smaller or lower than that in a case where the reception device number in the subgroup is a fourth number smaller than the first number.

(Supplementary note 7)

The transmission device according to any one of supplementary notes 4 to 6, in which
the network has a wireless network, and
the relay device is a wireless access node of the wireless network.
   (Supplementary note 8)

The transmission device according to any one of supplementary notes 1 to 7, in which
the communication data is communication data received from a transmission terminal, and
the determination means is configured to determine a data size or a bit rate to be applied to the communication data received from the transmission terminal.

### (Supplementary Note 9)

The transmission device according to any one of supplementary notes 1 to 8, in which
the communication data is data including a sound, an image, or a video, and
the generation means is configured to control the data size or the bit rate by changing a compression parameter of the data.

### (Supplementary Note 10)

A communication system including:
a transmission device configured to transmit communication data to one or more reception devices via a network; and
a server configured to specify a reception device number indicating the number of the reception devices that are a destination of the communication data, determine, in a case where the reception device number is a first number, a data size or a bit rate of the communication data such that a data size or a bit rate becomes smaller or lower than that in a case where the reception device number is a second number smaller than the first number, and transmit the data size or the bit rate determined to the transmission device,
in which the transmission device is configured to generate the communication data using the data size or the bit rate determined, and transmits the communication data generated to one or more of the reception devices that are the destination via the network.

### (Supplementary Note 11)

The communication system according to supplementary note 10, in which
a destination of the communication data is a terminal group including one or more of the reception devices, and
the server is configured to specify the reception device number based on group identification information for identifying the terminal group.

### (Supplementary Note 12)

A communication system including:
a transmission device configured to specify, in a case where communication data is transmitted to one or more reception devices via a network, a reception device number indicating the number of the reception devices that are a destination of the communication data; and
a server configured to determine, in a case where the reception device number is a first number, a data size or a bit rate of the communication data such that a data size or a bit rate becomes smaller or lower than that in a case where the reception device number is a second number smaller than the first number, and transmit the data size or the bit rate determined to the transmission device,
in which the transmission device is configured to generate the communication data using the data size or the bit rate determined, and transmits the communication data generated to one or more of the reception devices that are the destination via the network.
   (Supplementary note 13)

The communication system according to supplementary note 12, in which
a destination of the communication data is a terminal group including one or more of the reception devices, and
the transmission device is configured to specify the reception device number based on group identification information for identifying the terminal group.

### (Supplementary Note 14)

A transmission method executed in a transmission device that transmits communication data to one or more reception devices via a network, the transmission method including:
specifying a reception device number indicating the number of the reception devices that are a destination of the communication data;
determining, in a case where the reception device number is a first number, a data size or a bit rate of the communication data such that a data size or a bit rate becomes smaller or lower than that in a case where the reception device number is a second number smaller than the first number;
generating the communication data using the determined data size or bit rate; and
transmitting the communication data generated to one or more of the reception devices that are the destination via the network.

### (Supplementary Note 15)

A non-transitory computer-readable medium in which a program is stored for causing a computer, which transmits communication data to one or more reception devices via a network, to execute:
specifying a reception device number indicating the number of the reception devices that are a destination of the communication data;
determining, in a case where the reception device number is a first number, a data size or a bit rate of the communication data such that a data size or a bit rate becomes smaller or lower than that in a case where the reception device number is a second number smaller than the first number;
generating the communication data using the determined data size or bit rate; and
transmitting the communication data generated to one or more of the reception devices that are the destination via the network.

### REFERENCE SIGNS LIST

10 TRANSMISSION DEVICE
11 SPECIFICATION UNIT
12 DETERMINATION UNIT
13 GENERATION UNIT
14 TRANSMISSION UNIT
21 RECEPTION DEVICE
22 RECEPTION DEVICE
23 RECEPTION DEVICE
24 RECEPTION DEVICE
25 RECEPTION DEVICE
30 NETWORK
40 SERVER DEVICE
41 SPECIFICATION UNIT
42 DETERMINATION UNIT
43 COMMUNICATION UNIT
50 TRANSMISSION DEVICE
51 GENERATION UNIT
52 TRANSMISSION UNIT
61 RELAY DEVICE
62 RELAY DEVICE
70 TRANSMISSION DEVICE
71 CLASSIFICATION UNIT
1201 NETWORK INTERFACE
1202 PROCESSOR
1203 MEMORY

What is claimed is:

1. A transmission device that transmits communication data to one or more reception devices via a network, the transmission device comprising:
at least one memory storing instructions, and
at least one processor configured to execute the instructions to;
specify a reception device number indicating the number of the reception devices that are a destination of the communication data;
determine, in a case where the reception device number is a first number, a data size or a bit rate of the communication data such that a data size or a bit rate becomes smaller or lower than that in a case where the reception device number is a second number smaller than the first number;
generate the communication data using the determined data size or bit rate; and
transmit the generated communication data to one or more of the reception devices that are the destination via the network.

2. The transmission device according to claim 1, wherein
a destination of the communication data is a terminal group including one or more of the reception devices, and
the at least one processor is further configured to execute the instructions to specify the reception device number based on group identification information for identifying the terminal group.

3. The transmission device according to claim 2, wherein the at least one processor is further configured to execute the instructions to acquire the reception device number belonging to the terminal group from a server that manages information related to the terminal group.

4. The transmission device according to claim 1, wherein
the at least one processor is further configured to execute the instructions to;
classify one or more of the reception devices that are a destination of the communication data into a subgroup having an identical relay device to be routed through in the network;
the reception device number for each of the subgroups; and
determine a data size or a bit rate of the communication data by using the reception device number specified for each subgroup.

5. The transmission device according to claim 4, wherein the at least one processor is further configured to execute the instructions to determine a data size or a bit rate of the communication data by using the reception device number of the subgroup specified among the reception device number specified for each subgroup.

6. The transmission device according to claim 4, wherein the at least one processor is further configured to execute the instructions to determine, for each of the subgroups, in a case where the reception device number in the subgroup is a third number, a data size or a bit rate of the communication data such that a data size or a bit rate becomes smaller or lower than that in a case where the reception device number in the subgroup is a fourth number smaller than the third number.

7. The transmission device according to claim 4, wherein
the network has a wireless network, and
the relay device is a wireless access node of the wireless network.

8. The transmission device according to claim 1, wherein
the communication data is communication data received from a transmission terminal, and
the at least one processor is further configured to execute the instructions to determine a data size or a bit rate to be applied to the communication data received from the transmission terminal.

9. The transmission device according to claim 1, wherein
the communication data is data including a sound, an image, or a video, and
the at least one processor is further configured to execute the instructions to control the data size or the bit rate by changing a compression parameter of the data.

10.-13. (canceled)

14. A transmission method executed in a transmission device that transmits communication data to one or more reception devices via a network, the transmission method comprising:
specifying a reception device number indicating the number of the reception devices that are a destination of the communication data;
determining, in a case where the reception device number is a first number, a data size or a bit rate of the communication data such that a data size or a bit rate becomes smaller or lower than that in a case where the reception device number is a second number smaller than the first number;
generating the communication data using the determined data size or bit rate; and
transmitting the communication data generated to one or more of the reception devices that are the destination via the network.

15. A non-transitory computer-readable medium in which a program is stored for causing a computer, which transmits communication data to one or more reception devices via a network, to execute:
specifying a reception device number indicating the number of the reception devices that are a destination of the communication data;
determining, in a case where the reception device number is a first number, a data size or a bit rate of the communication data such that a data size or a bit rate becomes smaller or lower than that in a case where the reception device number is a second number smaller than the first number;
generating the communication data using the determined data size or bit rate; and
transmitting the communication data generated to one or more of the reception devices that are the destination via the network.
